(19) United States
(12) Patent Application Publication
(10) Pub. No.: US 2025/0050252 A1
(43) Pub. Date: Feb. 13, 2025

(54) FILTER FOR A SPRAY-COATING SYSTEM AND FILTER ASSEMBLY

(71) Applicant: Carl Freudenberg KG, Weinheim (DE)

(72) Inventors: Sascha SCHUMACHER, Wald-Michelbach (DE); Silvan SCHNEIDER, Ladenburg (DE); Juergen KLAUS, Hemsbach (DE)

(21) Appl. No.: 18/796,482

(22) Filed: Aug. 7, 2024

(30) Foreign Application Priority Data
Aug. 11, 2023 (EP) 23 191 020.9

(51) Int. Cl. B01D 35/02; B01D 35/30; B01D 39/14

(52) U.S. Cl. CPC B01D 35/02; B01D 35/30; B01D 39/14; B01D 2265/06; B01D 2279/40

(57) ABSTRACT

A filter for a spray coating system, including a housing with an inlet opening and an outlet opening and a flat filter medium folded in a zigzag-shaped manner received in the housing. The filter medium is spaced apart from the inlet opening for flow homogenization, with at least one collecting volume being formed.

### CROSS REFERENCE TO RELATED APPLICATIONS

This application claims benefit to European Patent Application No. EP 23 191 020.9, filed on Aug. 11, 2023, which is hereby incorporated by reference herein.

### FIELD

The invention relates to a filter for a spray-coating system and a filter assembly for a spray-coating system.

### BACKGROUND

A filter is known from WO 2023/062199 A1. Such filters are suitable for use in the field of spray cabinets for receiving paint mists and serve for the filtration of the exhaust air to be extracted from the spray cabinet. The exhaust air to be extracted from the spray cabinet is loaded with particles, which remain in the air in the course of coating an object, for example with a paint, rather than adhering to the object. Such particles, for example pigment particles, are also termed paint mist or overspray.

The amount of overspray, or paint mist, can be very large depending on the coating method, and the amount of overspray, or paint mist, can form half the overall amount of particles deployed by a coating system. Filtering systems for cleaning the air extracted from the spray cabinet are thus exposed to a high particle load, which has an effect, for example, on the time before filter replacement.

### SUMMARY

In an embodiment, the present disclosure provides a filter for a spray coating system, comprising a housing with an inlet opening and an outlet opening and a flat filter medium folded in a zigzag-shaped manner received in the housing. The filter medium is spaced apart from the inlet opening for flow homogenization, with at least one collecting volume being formed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows an isometric front view of a filter;

FIG. 2 schematically shows an isometric back view of a filter;

FIG. 3 schematically shows a sectional view of a housing of a filter;

FIG. 4 schematically shows a sectional view of a filter; and

FIG. 5 schematically shows a filter assembly for a spray-coating system.

### DETAILED DESCRIPTION

In an embodiment, the present invention provides a filter for a spray-coating system which has an extended time before filter replacement.

The filter according to an embodiment of the invention for a spray-coating system comprises a housing with an inlet opening and an outlet opening, wherein a flat filter medium folded in a zigzag-shaped manner is received in the housing, wherein the filter medium is spaced from the inlet opening with a collecting volume being formed.

The collecting volume arranged in the housing, which can also be termed a plenum, causes uniform loading of the filter medium also received in the housing. The air loaded with particles flows into the housing via the inlet opening, is first uniformly distributed over the surface of the filter medium in the region of the collecting volume, subsequently flows through the filter medium, and ultimately exits the housing via the outlet opening. By making the inflowing air uniform, in particular, in the region of the collecting volume, the filter medium is uniformly loaded with particles, which results in an extended time before filter medium replacement.

The collecting volume can extend over at least ¼, and the folded filter medium over at most ¾ of the depth of the housing. In this embodiment, the collecting volume takes up significant space within the housing and particularly good flow homogenization of the inflowing air can be achieved. This can thus result in particularly uniform loading of the filter medium.

The filter medium can be held in the housing in a form-fitting and/or force-fitting manner. Fixing in a force-fitting and/or form-fitting manner ensures that the filter medium is always spaced from the inlet opening for forming the collecting volume. Furthermore, it is provided that the filter medium is removed from the housing in a non-destructive manner and is separately disposed of.

Support elements can be arranged within the housing, wherein the filter medium is adjacent to the support elements at least in part. The support elements are preferably formed in such a manner that, on the one hand, they ensure the positioning of the filter medium within the housing. On the other hand, the support elements can also define, and thus ensure, the zigzag structure of the filter medium, thus the shape of the filter medium.

First support elements can be assigned to the collecting volume. The first support elements thus ensure a predetermined distance of the filter medium from the inlet opening and thus the provision of the collecting volume. The first support elements can be formed to be strip-shaped and can have V-shaped recesses which cause the shape of the edges of the filter medium facing the inlet opening to be defined. The first support elements can subdivide the collecting volume into a plurality of partial volumes.

The first support elements can extend beyond the edge of the filter medium and form shoulders on which the filter medium can be supported. This improves the stability of the filter medium fixed within the housing.

Second support elements can be provided, which are assigned to the outlet opening. The second support elements fix the filter medium in the region of the outlet opening and secure the filter medium in the housing. The second support elements can have a strip-like configuration and can be provided with recesses which serve to define the shape of the edges of the filter medium facing the outlet opening.

By providing the shape of the first support elements and the second support elements, a flat filter medium can be used, which is brought into a zigzag shape by the recesses made in the first support elements and the second support elements.

The edges of the filter medium assigned to the outlet opening can be shaped in such a manner that undercuts result on the sides of the edges facing the inlet opening. As seen from the inlet opening toward the outlet opening, the portions of the filter medium converging towards the edges become wider again in the region of the undercuts. The widening results in delayed loading of the filter medium in the region of the edges on the outlet side, and early wearing of the filter medium in the region of the edges can be avoided. The air is deflected in the regions of the undercuts. The paint particles can thus only follow the air flow to a limited extent, so that the filter medium is more slowly loaded with paint particles in the region of the undercuts. The arrangement of the undercuts in the region of the edges assigned to the outlet opening thus causes a further extension of the time before filter replacement.

Defining the shape of the filter medium by defining the shape of the undercuts is preferably achieved by the second support elements, which are keyhole-shaped in the region of the undercuts to be formed. The transitions from the conical region to the rounded undercuts can have sharp edges so that a porous filter medium is interlocked, and thus held in a fixed manner, at the sharp-edged transitions.

The edges assigned to the outlet opening can be rounded. This enables particularly good homogenization of the flow and particularly long extension of the time before the replacement of the filter medium. As seen in cross-section, the undercuts can have an essentially circular configuration. Preferably, the radius of the circular undercuts is between 5 mm and 25 mm.

The filter medium can comprise at least one layer of a nonwoven material. Due to its porosity, the material is particularly well suited to filter particles from a spray mist. Furthermore, the porous material of the filter medium can get interlocked with parts of the filter, in particular, on the support elements, and thus improve fixing of the filter medium in the housing. This is advantageous, in particular, because the filtering out of spray mist involves a relatively high mass loading of the filter medium.

The filter medium can be formed to have one or more layers, and can include, for example, different layers of nonwoven material having different porosities. It is also provided that at least individual layers of the filter medium have an electrostatic effect.

The housing and/or the support elements can be made of cardboard. This results in the filter being stable in shape and particularly cost-effective and simple to manufacture.

A filter assembly according to an embodiment of the invention for a spray-coating system comprises a first filter stage facing the spray mist and a second filter stage, wherein the second filter stage is a filter as described above.

The figures show a filter 1 for a spray-coating system, comprising a housing 2 of cardboard with an inlet opening 3 and the outlet opening 4. The housing 2 is essentially formed to be cuboid-shaped and includes an inlet opening 3 at one end face and an outlet opening 4 at the opposite end face. A flat filter medium 5 folded in a zigzag-shaped manner is received in the housing 2. The filter medium 5 comprises a layer 9 of nonwoven fabric. In an alternative embodiment the filter medium 5 comprises a plurality of layers 9 of nonwoven fabric.

The filter medium 5 is arranged within the housing 2 in such a manner that the filter medium 5 is spaced from the inlet opening 3 thus forming a collecting volume 6. In relation to the depth of the housing 2, the collecting volume 6 extends over ¼ of the depth and the folded filter medium over ¾ of the depth.

Support elements 7 are arranged in the housing 2, wherein the filter medium 5 is adjacent to the support elements 7. First support elements 7′ are assigned to the collecting volume 6 and second support elements 7″ are assigned to the outlet opening 4. Each of the support elements 7 has a strip-like structure and includes V-shaped recesses, which serve to define the shape of the edges of the filter medium 5 facing the inlet openings 3 and outlet openings 4, respectively. The support elements 7 are formed of cardboard. The support elements 7 serve to hold the filter medium 5 in the housing 2 in a form-fitting and force-fitting manner to prevent loosening.

The edges 8 of the filter medium 5 assigned to the outlet opening 4 are shaped in such a manner that undercuts 10 result on the side of the edges 8 facing the inlet opening 3. The edges 8 assigned to the outlet opening 4 are rounded. The shape is defined in such a manner that it results in rounded undercuts 10 having a radius from about 16 mm to 20 mm. The depth of the undercuts is between 17 mm and 12 mm. The shape of the undercuts 10 of the edges 8 is defined by correspondingly defining the shape of the recesses of the second support elements 7″.

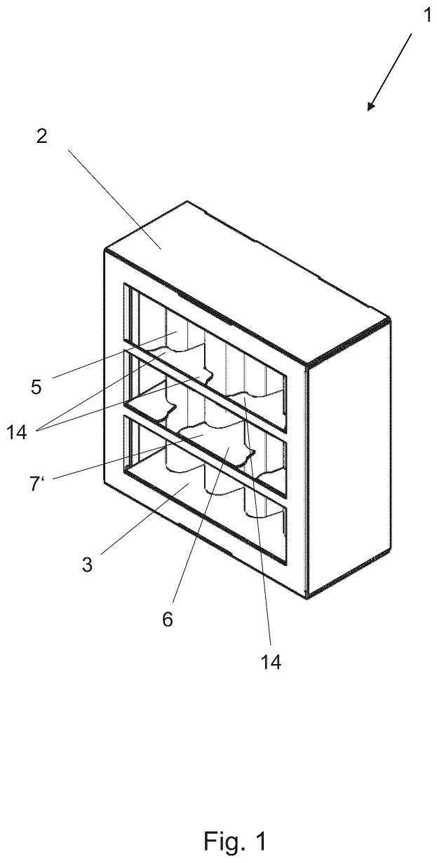

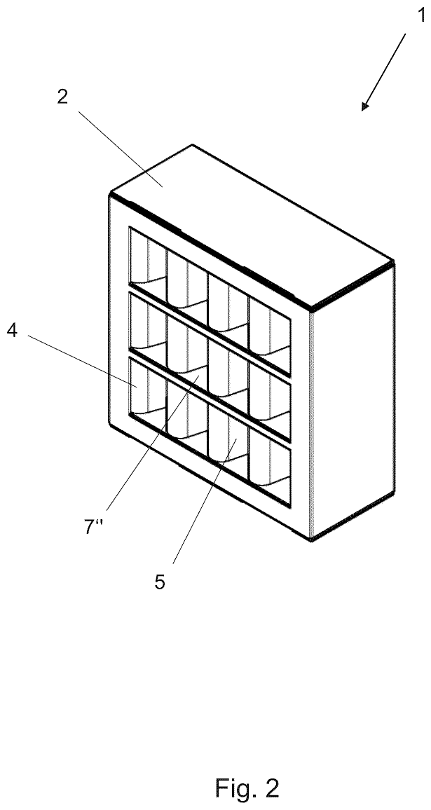

FIGS. 1 and 2 show isometric views of the filter 1, wherein FIG. 1 shows the inlet opening 3, the collecting volume 6 and the support elements 7′ assigned to the inlet opening 3, and FIG. 2 shows the outlet opening 4 and the support elements 7″ assigned to the outlet opening. The first support elements 7′ subdivide the collecting volume 6 into three partial volumes.

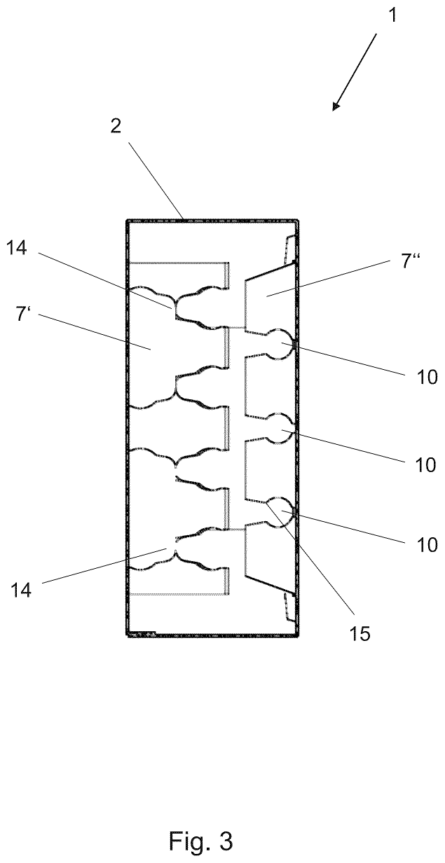

FIG. 3 shows a sectional view of the housing 2 with the support elements 7′, 7″ arranged therein. The V-shaped recesses in the support elements 7′, 7″ can be seen, in particular, to define the shape of the filter element 5 and the circular extensions in the recesses to define the shape of the circular undercuts 10 in the filter medium 5.

The first support elements 7′ cover the filter edges facing the collecting volume 6 and form shoulders 14, which support the filter medium 5 in the region of the filter edges.

The second support elements 7″ include keyhole-shaped recesses, in which the undercuts 10 of the filter medium 5 are formed. The transition 15 between the conical portion and the circular portion is formed to have sharp edges so that the filter medium 5 consisting of a porous material becomes interlocked in the transitions 15 on the second support elements 7″.

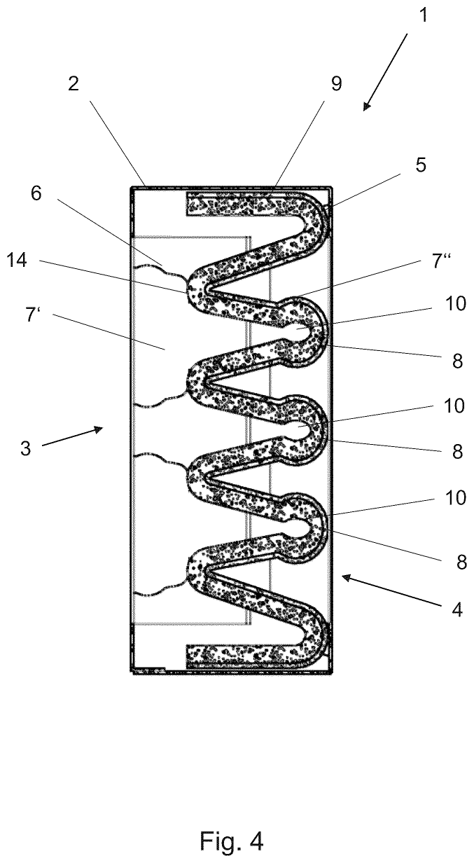

FIG. 4 shows a sectional view of the filter 1. In this figure, the undercuts 10 in the filter medium 5 folded in a zigzag-shaped manner can be clearly seen, which have their shape defined by the support elements 7″. The collecting volume 6 is also shown.

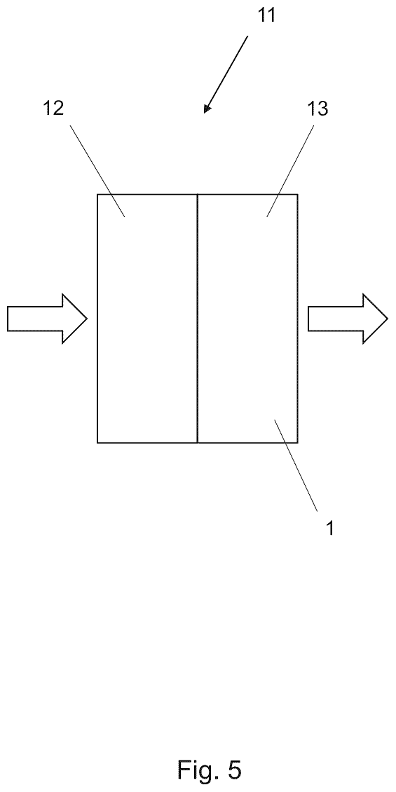

FIG. 5 shows a filter assembly 11 for a spray-coating system, wherein the filter 1 is part of the filter assembly 11. The filter assembly 11 is for the filtering of spray mist, in particular, for the filtering-out of overspray. The filter assembly 11 includes a first filter stage 12 facing the spray mist and a downstream second filter stage 13, wherein the second filter stage 13 is a filter 1 according to FIGS. 1 to 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A filter for a spray coating system, comprising:
a housing with an inlet opening and an outlet opening; and
a flat filter medium folded in a zigzag-shaped manner received in the housing,
wherein the filter medium is spaced apart from the inlet opening for flow homogenization, with at least one collecting volume being formed.

2. The filter according to claim 1, wherein the filter medium is held in the housing in a form-fitting and/or force-fitting manner.

3. The filter according to claim 1, wherein support elements are arranged in the housing, and wherein the filter medium abuts against the support elements at least in sections.

4. The filter according to claim 3, wherein first support elements of the support elements are assigned to the collecting volume.

5. The filter according to claim 4, wherein shoulders on which the filter medium is supported are formed from the first support elements.

6. The filter according to claim 3, wherein second support elements of the support elements are assigned to the outlet opening.

7. The filter according to claim 6, wherein the filter medium interlocks in sections with the second support elements.

8. The filter according to claim 1, wherein edges of the filter medium that are assigned to the outlet opening are formed such that undercuts are produced on a side of the edges which faces the inlet opening.

9. The filter according to claim 8, wherein the edges assigned to the outlet opening are rounded.

10. The Filter according to claim 1, wherein the filter medium comprises at least one layer of nonwoven material.

11. The filter according to claim 3, wherein the housing and/or the support elements are formed from cardboard.

12. The filter according to claim 1, wherein the at least one collecting volume extends over at least ¼ of the depth and the folded filter medium over at most ¾ of the depth of the housing.

13. A filter arrangement for a spray coating system, comprising a first filter stage facing a spray mist and a second filter stage downstream of the first filter stage, wherein the second filter stage is the filter according to claim 1.
